(19) United States
(12) Patent Application Publication
(10) Pub. No.: US 2026/0216934 A1
(43) Pub. Date: Jul. 30, 2026

(54) MOLD CLAMPING DEVICE AND MOLD CLAMPING METHOD

(71) Applicant: The Japan Steel Works, Ltd., Tokyo (JP)

(72) Inventors: Atsushi TSUKAMOTO, Aichi (JP); Shizuo JINNO, Aichi (JP); Shinji HAYASHI, Aichi (JP); Toshifumi MITSUZUKA, Aichi (JP); Atsushi KUMAGAI, Aichi (JP)

(73) Assignee: The Japan Steel Works, Ltd., Tokyo (JP)

(21) Appl. No.: 19/432,747

(22) Filed: Dec. 24, 2025

(30) Foreign Application Priority Data
Jan. 30, 2025 (JP) 2025-014309

(51) Int. Cl. B29C 45/67

(52) U.S. Cl. CPC B29C 45/6778

(57) ABSTRACT

A mold clamping device that mold clamps a movable mold attached to a movable platen movable by a mold opening/closing mechanism and a fixed mold attached to a fixed platen includes a mold clamping cylinder that includes a piston provided at a rod that transmits a mold clamping force to the movable platen at the time of mold clamping and that performs mold clamping via the rod by movement of the piston, wherein the mold clamping cylinder includes a first cylinder chamber for moving the piston in a mold closing direction, a third cylinder chamber for moving the piston in a mold opening direction, and a second cylinder chamber that is located between the first cylinder chamber and the third cylinder chamber and adjusts a position of the piston at least at the time of mold opening.

### CROSS-REFERENCE TO RELATED APPLICATIONS

This application is based on and claims the benefit of priority from Japanese Patent Applications No. 2025-014309 filed on January 30, 2025, the entire contents of which is incorporated herein by reference.

### BACKGROUND OF THE INVENTION

### Field of the Invention

The present invention relates to a mold clamping device that mold clamps a movable mold attached to a movable platen movable by a mold opening/closing mechanism and a fixed mold attached to a fixed platen.

### Description of Related Art

As this type of mold clamping device, a device described in JP 2008 055862 A is known. This mold clamping device includes a mold opening/closing mechanism that moves a movable platen to which a movable mold is attached close to and away from a fixed platen to which a fixed mold is attached, a mold clamping cylinder that mold clamps the fixed mold and the movable mold, a tie bar that has an engagement portion formed on an outer periphery and is pulled by the mold clamping cylinder, and a half nut that can be engaged with and disengaged from the engagement portion. The mold clamping device includes a position adjustment rod disposed outside a platen opposite a mold attachment face of a piston of the mold clamping cylinder, a plurality of adjustment cylinders disposed in parallel with the rod on the fixed platen or the movable platen where the mold clamping cylinder is disposed and including a rod, and a coupling member that couples the rod of the adjustment cylinder and the position adjustment rod.

### SUMMARY OF THE INVENTION

An object of the present disclosure is to provide a mold clamping device capable of adjusting the position of a transmission member and capable of achieving at least one of improvement in work efficiency around a nozzle of an injection device, reduction in the overall length of the mold clamping device, reduction in the number of parts, reduction in the number of assembling steps, and reduction in cost. Other problems and novel features will be apparent from the description of the present specification and the accompanying drawings.

A mold clamping device according to an embodiment includes a mold clamping cylinder that performs mold clamping via a transmission member by movement of a piston provided at the transmission member that transmits mold clamping force to a movable platen at the time of mold clamping. The mold clamping cylinder includes a mold clamping cylinder chamber for moving the piston in a mold closing direction, a mold opening cylinder chamber for moving the piston in a mold opening direction, and an adjustment cylinder chamber located between the mold clamping cylinder chamber and the mold opening cylinder chamber and for adjusting a position of the piston.

According to the mold clamping device of the present disclosure, since the mold clamping cylinder includes the mold clamping cylinder chamber, the mold opening cylinder chamber, and the adjustment cylinder chamber, at least one effect of improving the work efficiency around the nozzle of the injection device, reducing the overall length of the mold clamping device, reducing the number of parts, reducing the number of assembly steps, and reducing the cost is exhibited as compared with a case where the adjustment device of the transmission member is assembled to the mold clamping device as an independent unit.

### BRIEF DESCRIPTION OF THE DRAWINGS

FIG. 1 is a schematic view schematically illustrating an overall configuration of a mold clamping device according to an embodiment;

FIG. 2 is a schematic view schematically illustrating a configuration of a mold clamping cylinder according to an embodiment;

FIG. 3A is a diagram for describing the operation of the mold clamping cylinder according to the embodiment;

FIG. 3B is a diagram for describing the operation of the mold clamping cylinder according to the embodiment; FIG. 3C is a diagram for describing the operation of the mold clamping cylinder according to the embodiment;

FIG. 3C is a diagram for describing the operation of the mold clamping cylinder according to the embodiment;

FIG. 3D is a diagram for describing the operation of the mold clamping cylinder according to the embodiment;

FIG. 4A is a diagram for describing half nut coupling and decoupling between a half nut and a rod according to the embodiment and an operation of a mold clamping cylinder related thereto;

FIG. 4B is a diagram for describing half nut coupling and decoupling between a half nut and a rod according to the embodiment and an operation of a mold clamping cylinder related thereto;

FIG. 4C is a diagram for describing half nut coupling and decoupling between a half nut and a rod according to the embodiment and an operation of a mold clamping cylinder related thereto;

FIG. 4D is a diagram for describing half nut coupling and decoupling between a half nut and a rod according to the embodiment and an operation of a mold clamping cylinder related thereto; and

FIG. 5 is a schematic view schematically illustrating a configuration of a mold clamping cylinder according to a modification.

### DETAILED DESCRIPTION OF PREFERRED EMBODIMENTS

Hereinafter, an embodiment of the present invention will be described with reference to the drawings. However, the present invention is not limited to the following exemplary embodiments. In order to clarify the description, the following description and drawings are simplified as appropriate. In the drawings, the same elements are denoted by the same reference numerals, and redundant description is omitted as necessary. In addition, hatching is omitted in some parts so as not to complicate the drawing.

### Device configuration

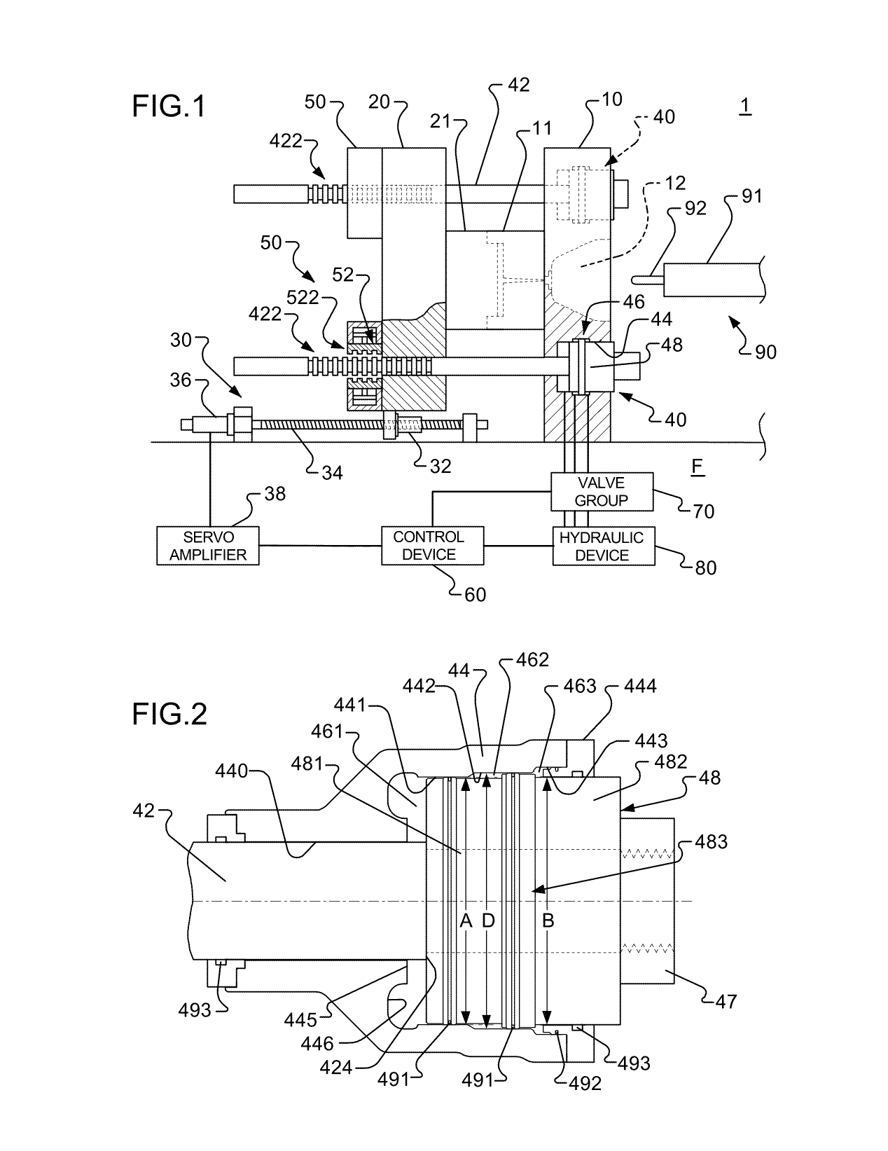

FIG. 1 is a schematic view schematically illustrating an overall configuration of a mold clamping device 1 according to an embodiment. In FIG. 1, a part is illustrated as a cross-sectional view for easy understanding.

As shown in FIG. 1, the mold clamping device 1 according to the present embodiment is used in an injection molding machine that performs injection molding of a molded product using resin, metal, ceramic, or the like as a raw material, and here, an injection device 90 is provided on a floor face F as an installation surface so as to be movable forward and backward in a direction (hereinafter, it is appropriately referred to as a left-right direction) approaching and being away from each other with respect to the mold clamping device 1. Note that, Reference numeral 91 denotes an injection cylinder of the injection device 90, and reference numeral 92 denotes a nozzle of the injection device 90.

The mold clamping device 1 includes a fixed platen 10, a movable platen 20, a mold opening/closing mechanism 30, and the like. Hereinafter, the configuration of the mold clamping device 1 will be described in detail.

### Fixed platen 10

The fixed platen 10 has a predetermined thickness and is formed in an almost rectangular shape. The fixed platen 10 is erected with respect to the floor face F so that a side face (left side face in the figure) on the mold opening direction side is a mold attachment face, in other words, the mold attachment face faces in one side (left side in the figure). A fixed mold 11 is detachably provided on the mold attachment face. The fixed mold 11 is formed so as to be able to match a movable mold 21 described later. The fixed platen 10 has an injection hole 12, at a substantially central portion in the vertical direction, for injecting and filling a molten resin from the injection device 90 into the fixed mold 11, and the molten resin can be injected into a cavity formed when the fixed mold 11 and the movable mold 21 are mold clamped through the injection hole 12. The fixed platen 10 includes mold clamping cylinders 40, which will be described in detail later, in the vicinities of four corners in a plane orthogonal to the left-right direction which is the mold opening/closing direction according to the present embodiment.

### Movable platen 20

The movable platen 20 is located on the mold opening direction side of the fixed platen 10, and has a predetermined thickness and is formed in an almost rectangular shape. The movable platen 20 is disposed upright with respect to the floor face F so that a side face (right side face in the drawing) on the mold closing direction side serves as a mold attachment face, in other words, the mold attachment face faces in the other side (right side in the drawing). The movable mold 21 is detachably provided on the mold attachment face. The movable platen 20 has insertion holes through which rods 42 to be described later of the mold clamping cylinders 40 can be inserted in the vicinities of four corners in a plane orthogonal to the left-right direction. In the present embodiment, the rod 42 is configured as a tie bar, and when the rod 42 is inserted into the insertion hole, the movable platen 20 is guided by the rod 42 and horizontally movable so as to approach and be away from the fixed platen 10 along the left-right direction by the mold opening/closing mechanism 30 to be described later.

### Mold opening/closing mechanism 30

The mold opening/closing mechanism 30 horizontally moves the movable platen 20 along the left-right direction with respect to the fixed platen 10, and supports the movable platen 20 by being interposed between the floor face F and the movable platen 20 and being connected to the lower face of the movable platen. In the present embodiment, the mold clamping device 1 includes two mold opening/closing mechanisms 30, but the present invention is not limited thereto, and one or three or more mold opening/closing mechanisms may be provided. In the mold opening/closing mechanism 30, a drive source 36 such as a servomotor is fixed to a bracket installed on the floor face F. The brackets installed at two locations on the floor face F have bearings, and both ends of a ball screw 34 are rotatably held by the bearings. On the other hand, a bracket is provided on the lower face of the movable platen 20, and a ball screw nut 32 is fixed to the bracket. The ball screw 34 is screwed into the ball screw nut 32. The ball screw 34 is rotationally driven by driving of the drive source 36, and the ball screw nut 32 and the movable platen 20 are movable in the left-right direction of FIG. 1.

When the ball screw 34 is rotated by the drive source 36, the movable platen 20 is guided by a rod 42 to be described later with respect to the fixed platen 10 and horizontally moves along the left-right direction together with the ball screw nut 32. A servomotor of the drive source 36 includes a rotary encoder that detects a rotation angle, and a position (mold opening position) of the movable platen 20 in a mold opening/closing direction (left-right direction in the figure) with respect to the fixed platen 10 can be detected by the rotary encoder. The drive source 36 is connected to a control device 60 via a servo amplifier 38, and can be controlled by the control device 60.

In addition to the structure in which the drive shaft of the servomotor is directly connected to the ball screw 32 as illustrated in FIG. 1, the connection between the drive source 36 and the ball screw 32 is preferably performed so that, for example, a drive pulley is provided on the drive shaft of the drive source 36, a driven pulley is provided on the ball screw 34, an endless timing belt runs between the drive pulley and the driven pulley, and the rotational driving force of the drive source 36 is indirectly transmitted to the ball screw 34. Further, one ball screw 34 may be rotationally driven by a plurality of drive sources 36. In addition, the mold opening/closing mechanism 30 may include a feed screw mechanism or a rack-and-pinion mechanism other than a ball screw for at least a part, and actuators thereof are not limited to an electric motor such as a servomotor, and may include a fluid pressure cylinder using fluid pressure such as hydraulic pressure.

### Mold clamping cylinder 40

The mold clamping cylinder 40 is a reciprocating moving cylinder having a stroke related to pressure increase, strong mold opening, and tie bar position adjustment, and a stroke to which a predetermined margin is added. As described above, the mold clamping cylinders 40 are disposed in the vicinities of the four corners in the vertical plane of the fixed platen 10. The rods 42 of the four mold clamping cylinders 40 are configured as tie bars that are inserted into the vicinities of the four corners in the vertical plane of the movable platen 20 to guide the movement of the movable platen 20. The rod 42 is provided so that the direction of the axial center is the left-right direction. The rod 42 has a plurality of fitting grooves 422 over a predetermined length in the axial direction on the outer periphery thereof. The rod 42 functions as a transmission member that transmits mold clamping force to the movable platen 20 at the time of mold clamping by being coupled to a half nut 50 described later.

The mold clamping cylinder 40 is actuated by hydraulic pressure to move the rod 42 along the left-right direction, so that it is possible to perform pressure increase as mold clamping of the fixed mold 11 and the movable mold 21 in the mold closed state, strong mold opening after injection molding, tie bar position adjustment, and the like. The mold clamping cylinder 40 has a plurality of cylinder chambers 46 between the rod 42, and a cylinder tube 44 surrounding the rod 42 and the piston 48. In other words, a mold clamping cylinder including a piston fix to a transmission member (a piston provided at a transmission member). The piston 48 is slidably inserted into the cylinder chamber 46. The mold clamping cylinder 40 can perform mold clamping or the like via the rod 42 by the movement of the piston 48. Note that the cylinder tube 44 may be formed independently from the fixed platen 10, or may be integrally formed.

In the present embodiment, the cylinder chamber 46 includes three first to third cylinder chambers 461 to 463 (see FIG. 2), and can increase the pressure at the time of mold clamping, perform strong mold opening, and perform the tie bar position adjustment. In the hydraulic pipeline to the hydraulic device 80 of each of the three first to third cylinder chambers 461 to 463, a pressure sensor (not illustrated) for measuring the pressure of the hydraulic oil and a valve for realizing supply of an accurate amount of the hydraulic oil are interposed, and these valves are illustrated as a valve group 70 in FIG. 1. As such a valve, it is preferable to use a so-called direction/flow rate control valve that is driven and controlled by the control device 60 so that the flow rate and the flow direction, that is, supply/discharge of the hydraulic oil can be switched. A servo-valve, a cartridge valve, a COMNICA valve, or the like may be used as the valve.

The hydraulic device 80 is disposed on the floor face F around the mold clamping device 1, and includes a pump, a tank, and the like for supplying hydraulic oil to the mold clamping cylinder 40 described above. It is preferable that the pump has a servomotor capable of controlling the number of revolutions in order to realize appropriate supply of the hydraulic oil. In this case, after the operation of the mold clamping cylinder 40, the rotation of the servomotor may be stopped or maintained at the minimum rotation speed. The hydraulic device 80 may supply hydraulic oil to various other mechanisms operated by hydraulic pressure, for example, when the mold opening/closing mechanism 30 and the half nut 50 are driven and controlled by hydraulic pressure. In the present embodiment, the mold clamping cylinder 40 is provided in the fixed platen 10. Therefore, there is a case where the distance of the pipeline of the hydraulic device 80 can be shortened, or there is a case where it is not necessary to include the flexible hose for the pipeline as compared with the case where the mold clamping cylinder 40 is provided in the movable platen 20, and as a result, the cost can be reduced. In addition, the energy consumption amount at the time of the mold opening/closing movement of the movable platen 20 can be reduced as compared with the case where the mold clamping cylinder 40 is provided in the movable platen 20. Furthermore, when the hydraulic oil is supplied by the hydraulic device 80, the mold clamping cylinder 40 can appropriately move the piston 48 in the mold opening/closing direction (left-right direction in FIG. 1).

As illustrated in FIG. 2, the rod 42 or the end, of a fastening nut 47, on the mold closing direction side, which is a fixing member for fixing the piston 48 to the rod 42 protrudes from the piston 48 and is exposed from the fixed platen 10. The position of the rod 42 can be accurately measured by measuring the protrusion amount of the protrusion by a sensor (not illustrated) in a non-contact manner.

### Half nut 50

A total of four half nuts 50, which are coupling portions, are provided on the side face of the movable platen 20 on the mold opening direction side so as to correspond to the rods 42 inserted into the insertion holes near the four corners of the movable platen 20 described above. The half nut 50 functions as a coupling portion, of the movable platen 20, for coupling (half nut coupling) the rod 42 adjacent to the half nut 50 in order to transmit the mold clamping force of the mold clamping cylinder 40 to the movable mold 21. In other words, it can be said that the rod 42 is a tie bar that is inserted through the movable platen 20 so as to be able to guiding the movable platen 20, is capable of being coupled to the movable platen 20 by the half nut 50, and generates a mold clamping force by being pulled by the mold clamping cylinder 40 and extending at the time of mold clamping.

The half nut 50 includes a pair of half nut blocks 52. The half nut block 52 has a plurality of fitting teeth 522 spaced apart at equal intervals along the left-right direction on a face facing the rod 42. Part of the peripheral face of each of the four rods 42 in total on the mold opening direction side has a plurality of annular fitting grooves 422, at equal intervals along the left-right direction, that can be fitted (coupled) to the corresponding fitting teeth 522 of the half nut 50. The axial length of the rod 42 at the half nut 50 is set shorter than the axial length of the region where the fitting groove 422 of the rod 42 is formed. In FIG. 1, for easy understanding, the upper half nut 50 is shown in a state of being coupled to the rod 42, and the lower half nut 50 is shown in a state of being uncoupled from the rod 42.

The half nut block 52 is connected to a driving means such as a cylinder which is driven to extend and retract by a fluid pressure such as hydraulic pressure or a ball screw mechanism which is driven to advance and retract by an electric motor such as a servomotor, and is driven so as to be able to advance and retract so that the fitting teeth 522 are fitted to the corresponding fitting grooves 422 of the rod 42 or the fitting is released.

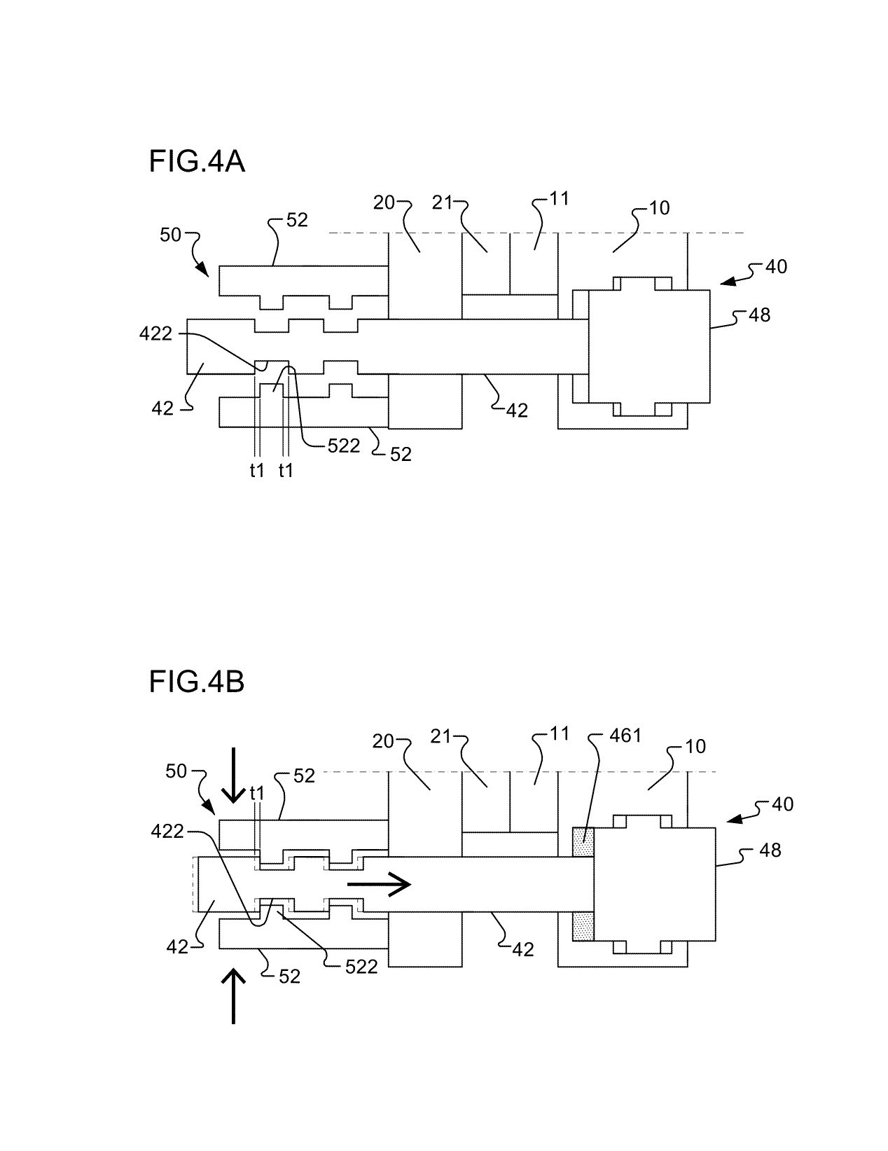

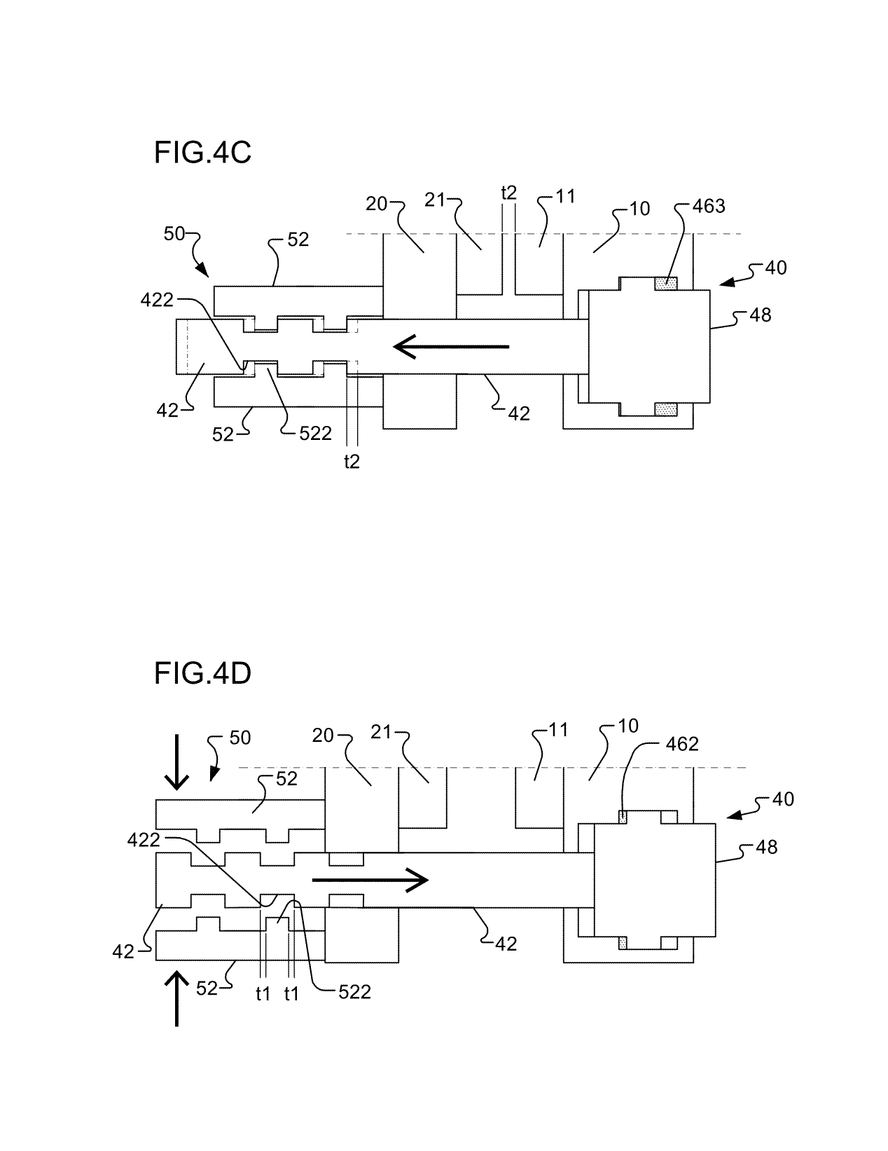

In addition, when the fitting groove 422 of the rod 42 of the mold clamping cylinder 40 and the fitting tooth 522 of the half nut 50 come into contact with each other at the time of coupling therebetween (specifically, the edge portion of the fitting groove 422 and the fitting tooth 522 of the half nut 50 come into contact with each other), either or both of them may be damaged. In order to avoid such contact as much as possible, the length (tooth width) of the fitting tooth 522 in the mold opening/closing direction (left-right direction) is formed to be shorter than the groove width of the facing fitting groove 422 (see FIG. 4(a)). It is necessary to appropriately position the fitting tooth 522 and the fitting groove 422 so as to avoid such contact, and this positioning work is the tie bar position adjustment described above. Details of the tie bar position adjustment will be described later.

### Control device 60

The control device 60 includes hardware such as a central processing unit (CPU) (not illustrated), a memory, and a storage device, and these hardware cooperate to perform drive control of various devices, here, the drive source 36 via the servo amplifier 38, the half nut 50, the valve group 70, the hydraulic device 80, the injection device 90, and the like. The control device 60 may further include an input/output unit to have a function of receiving an input from a user and perform outputting via a display, for example, a function of performing various setting inputs and displays of the mold clamping device 1. The control device 60 may be provided to be incorporated in any of the mold clamping device 1 and the injection device 90, may be provided independently in the vicinity of the mold clamping device 1, for example, as an operation panel or a control panel, or may be constructed by an information processing device such as a personal computer (PC), for example.

### Detailed structure of mold clamping cylinder 40

The structure of the mold clamping cylinder 40 described above will be described in detail with reference to FIG. 2. FIG. 2 is a schematic view schematically illustrating the mold clamping cylinder 40 according to the present embodiment. In FIG. 2, for the sake of explanation, only the cylinder tube 44 is shown in a longitudinal cross section.

As illustrated in FIG. 2, the rod 42 has a step portion 424. The diameter of the rod 42 in the mold closing direction (right side) from the step portion 424 is smaller than the diameter in the mold opening direction (left side) from the step portion 424. The outer peripheral face from the end portion of the rod 42 to the vicinity of the end portion in the mold closing direction has a thread groove (male thread). On the other hand, the fastening nut 47 has a center hole in the mold opening/closing direction, and has a thread groove (female thread) on the inner peripheral face of the center hole. Then, in a state where the rod 42 inserts through the piston 48, the female thread of the fastening nut 47 is screwed into the thread groove (male thread) of the rod 42, so that a portion in the vicinity of the center hole of the face of the piston 48 on the mold clamping cylinder chamber 461 side contacts the step portion 424 of the rod 42. The piston 48 is fixed to the rod 42. The method of fixing the rod 42 and the piston 48 is not limited to the above.

The piston 48 of the mold clamping cylinder 40 has first and second small diameter portions 481, 482 having substantially the same diameter, and has a large diameter portion 483 having a diameter larger than those of the first and second small diameter portions 481, 482 between the first and second small diameter portions. In the present embodiment, the large diameter portion 483 is located substantially at the center of the piston 48 in the left-right direction. By forming the large diameter portion 483, a step is formed on the peripheral face of the piston 48. Although the first and second small diameter portions 481, 482 have been described to have substantially the same diameter, either one may have a smaller diameter than the other. In this case, there is a difference in the pressure receiving area of the piston 48 described later, but the hydraulic oil may be supplied in consideration of the difference.

The cylinder tube 44 has steps so that the inner circumference is enlarged in the mold closing direction (right side in FIG. 2) so that the cylinder chambers are defined at the end face of the piston 48 on the mold opening direction side and at both left and right sides of the large diameter portion 483. Specifically, the cylinder tube 44 includes, in order from the mold opening direction side to the mold closing direction side, a small diameter inner peripheral portion 440 that is in contact with the rod 42, a first inner peripheral portion 441 that is larger in diameter than the small diameter inner peripheral portion 440 and is in contact with the first small diameter portion 481, a second inner peripheral portion 442 that is larger in diameter than the first inner peripheral portion 441 and is in contact with the large diameter portion 483, a third inner peripheral portion 443 that is larger in diameter than the second inner peripheral portion, and a lid portion 444 that closes the cylinder tube 44 and is in contact with the second small diameter portion 482. Since the cylinder tube 44 includes the small diameter inner peripheral portion 440, the first to third inner peripheral portions 441 to 443, and the lid portion 444, steps are formed so that the inner periphery expands in diameter in the mold clamping direction (right side in FIG. 2), and the first to third cylinder chambers 461 to 463 can be defined between the cylinder tube and the piston 48.

The first cylinder chamber 461 is a space surrounded by (facing) the wall face 445 in the vertical direction provided between the small diameter inner peripheral portion 440 and the first inner peripheral portion 441, the first inner peripheral portion 441, and the end face of the piston 48 on the mold opening direction side, and functions as a mold clamping cylinder chamber which is a pressure chamber for moving the piston 48 in the mold closing direction by supply of hydraulic oil. The first cylinder chamber 461 is mainly used for pressure increase, that is, mold clamping. The wall face 445 in the vertical direction has an annular recess 446. Accordingly, even when the piston 48 is moved in the mold opening direction and contacts the wall face 445 in the vertical direction, a space in which the hydraulic oil remains can be maintained between the recess 446 and the piston 48. Therefore, the hydraulic oil can be supplied to the first cylinder chamber 461 even in the contact state, and the piston 48 can be moved in the mold closing direction.

The second cylinder chamber 462 is a space surrounded by the first small diameter portion 481, the large diameter portion 483, and the second inner peripheral portion 442, and functions as an adjustment cylinder chamber which is a pressure chamber for moving the piston 48 in the mold closing direction by the supply of the hydraulic oil, adjusting the position of the piston 48, and thus adjusting the position of the rod 42 (tie bar position adjustment). The second cylinder chamber 462 is mainly used when the piston 48 advances (moves in the mold closing direction) at the time of tie bar position adjustment. That is, the second cylinder chamber 462 is used to move the piston 48, and thus the rod 42, in the mold closing direction as in the first cylinder chamber 461, but the pressure receiving area of the piston 48 is smaller than that of the first cylinder chamber 461. Therefore, the piston 48 can be quickly moved with a small amount of hydraulic oil, and the pressure chamber is extremely suitable for moving the piston 48 forward as the tie bar position adjustment. Since the length of the second cylinder chamber 462 in the left-right direction is constantly longer than that of the first cylinder chamber 461, it is possible to maintain a space in which the hydraulic oil remains even when the piston 48 is moved in the mold opening direction and contacts the wall face 445 in the vertical direction.

The third cylinder chamber 463 is a space surrounded by the large diameter portion 483, the second small diameter portion 482, the third inner peripheral portion 443, and the lid portion 444, and functions as a mold opening cylinder chamber that moves the piston 48 in the mold opening direction when hydraulic oil is supplied. The third cylinder chamber 463 is mainly used at the time of strong mold opening of the molded product or when the piston 48 is retracted (moved in the mold opening direction) at the time of tie bar position adjustment. Generally, a molded product after injection molding is stuck to a cavity surface of each mold, and high resistance is generated when the mold is opened, so that force is required for opening the mold. Here, the strong mold opening refers to a process of performing the mold opening by the hydraulic pressure, that is, the mold clamping cylinder 40 by a slight stroke since the force is insufficient to open the mold only with the mold opening/closing mechanism 30.

In the third cylinder chamber 463, the pressure receiving area of the piston 48 is substantially the same as that of the second cylinder chamber 462, and the formula of (πD²/4)-(πA²/4)=(πD²/4)-(πB²/4) is established, where D is an inner diameter of the second inner peripheral portion 442, A is an inner diameter of the first inner peripheral portion 441, and B is a diameter of the second small diameter portion 482. Therefore, as in the second cylinder chamber 462, the third cylinder chamber 463 is a pressure chamber that can quickly move the piston 48 with a small amount of hydraulic oil and is extremely suitable for retracting the piston 48 as a tie bar position adjustment. In addition, since the pressure receiving areas are substantially the same, bidirectional flow rate control by the control valves 71 and 72 is easy at the time of mold thickness adjustment by mold replacement or the like, at the time of core back control in the case of performing foam molding (core back molding), or the like.

In FIG. 2, reference numeral 491 denotes an annular piston seal, reference numeral 492 denotes an O-ring, and reference numeral 493 denotes an annular packing. Therefore, the first to third cylinder chambers 461 to 463 have mutually high liquid tightness. Note that the seal of the mold clamping cylinder 40 is not limited to that described above, but in the present embodiment, the first small diameter portion 481 has two slightly enlarged ridge portions, and the piston seal 491 is provided between the two ridge portions (substantially at the center in the left-right direction). Also, the large diameter portion 483 has a ridge portion having a slightly enlarged diameter, and the piston seal 491 is provided between the two ridge portions. By forming the slightly large diameter ridge portion in this manner, it is possible to reduce the load on the piston seal 491 and further improve the liquid tightness. Note that the ridge portion is not essential.

### Tie bar position adjustment

Hereinafter, the tie bar position adjustment will be described in detail. The tie bar position adjustment is performed, for example, every cycle of injection molding. One cycle specifically refers to a series of operations of mold closing, half nut coupling, pressure increasing (mold clamping), pressure releasing, strong mold opening, half nut decoupling, and mold opening. In other words, it can be said that the tie bar position adjustment is performed in a state where the mold clamping force of the mold clamping cylinder 40 is not transmitted to the movable platen 20 in one cycle (from the end of strong mold opening to the start of half nut coupling (start of an engagement) of the next cycle (timing)). At this time, as the tie bar position adjustment, the rod 42 is slightly moved by t1 in (d) of FIG. 4 in the mold closing direction so that the half nut coupling of the next cycle is correctly performed at the mold opening position and the like every time, that is, the fitting tooth 522 of the half nut 50 precisely faces the fitting groove 422 of the rod 42 at the time of mold closing and the fitting (mating of teeth) is performed without contact.

The tie bar position adjustment is performed, for example, when the fixed mold 11 and the movable mold 21 is replaced. This is because the molds are not uniform in thickness, and generally have different thicknesses. Therefore, it is necessary to adjust the fitting tooth 522 of the half nut 50 to precisely face the fitting groove 422 of the rod 42 at the position of the half nut coupling. The tie bar position adjustment in this case is generally performed in a mold closed state in which the movable mold 21 is closed with respect to the fixed mold 11. More specifically, when the fitting groove 422 of the rod 42 and the fitting tooth 522 of the half nut 50 cannot be fitted without precisely facing each other at the time of mold thickness adjustment immediately after mold replacement (at the time of newly closing the mold), the rod 42 is moved to the precisely facing position. More specifically, the rod 42 is moved in the mold closing direction or the mold opening direction so that the fitting tooth 522 of the half nut 50 precisely faces the fitting groove 422 of the rod 42 at the time of mold closing and the fitting (mating of teeth) is performed without contact. When the rod 42 is moved to such a precisely facing position, in a case where the precisely facing position can be reached earlier by moving the rod 42 in the mold closing direction, that is, when the precisely facing position is close to the mold closing direction, the hydraulic oil is supplied to the second cylinder chamber 462. On the other hand, in a case where the precisely facing position can be reached earlier by moving the rod 42 in the mold opening direction, that is, in a case where the precisely facing position is close to the mold opening direction, the hydraulic oil is supplied to the third cylinder chamber 463. The adjustment of the position of the rod 42, that is, the piston 48 at the time of mold thickness adjustment is performed in a state in which the mold clamping force of the mold clamping cylinder 40 is not transmitted to the movable platen 20 and the movable mold 21 although being in the mold closed state, that is, in a state in which the half nut 50 is not engaged with the fitting groove 422 of the rod 42.

However, the mold clamping cylinder 40 has offset positions on the mold opening side and the mold closing side (pressure increasing side), and when the position of the piston 48 is too close to the end due to the movement of the rod 42 at the time of the tie bar position adjustment, there is a possibility that a stroke of pressure increase or strong mold opening cannot be taken. Therefore, for example, in the case of the offset position where there is no stroke on the strong mold opening side, the rod 42 is preferably moved so that the fitting groove 422 is positioned at another precisely facing position where the stroke on the strong mold opening side can be secured using the second cylinder chamber 462 regardless of the distance to the nearest precisely facing position at the time of starting the tie bar position adjustment. Similarly, when the stroke at the time of mold clamping cannot be sufficiently taken, the rod 42 may be moved so that the fitting groove 422 is positioned at another precisely facing position where the stroke at the time of mold clamping can be secured using the third cylinder chamber 463 regardless of the distance to the nearest precisely facing position at the time of starting the tie bar position adjustment. For example, assuming that the total mold thickness of the fixed mold 11 and the movable mold 21 is the smallest thickness, it is preferable to perform setting so that, every time the mold thickness increases by one pitch of the teeth of the half nut 50, the half nut coupling is performed from the position of the fitting groove 422 of the rod 42 closest to the fixed platen 10 to the position of the next fitting groove 422 of the fitting groove 422, that is, the position of the fitting groove 422 adjacent in the mold opening direction.

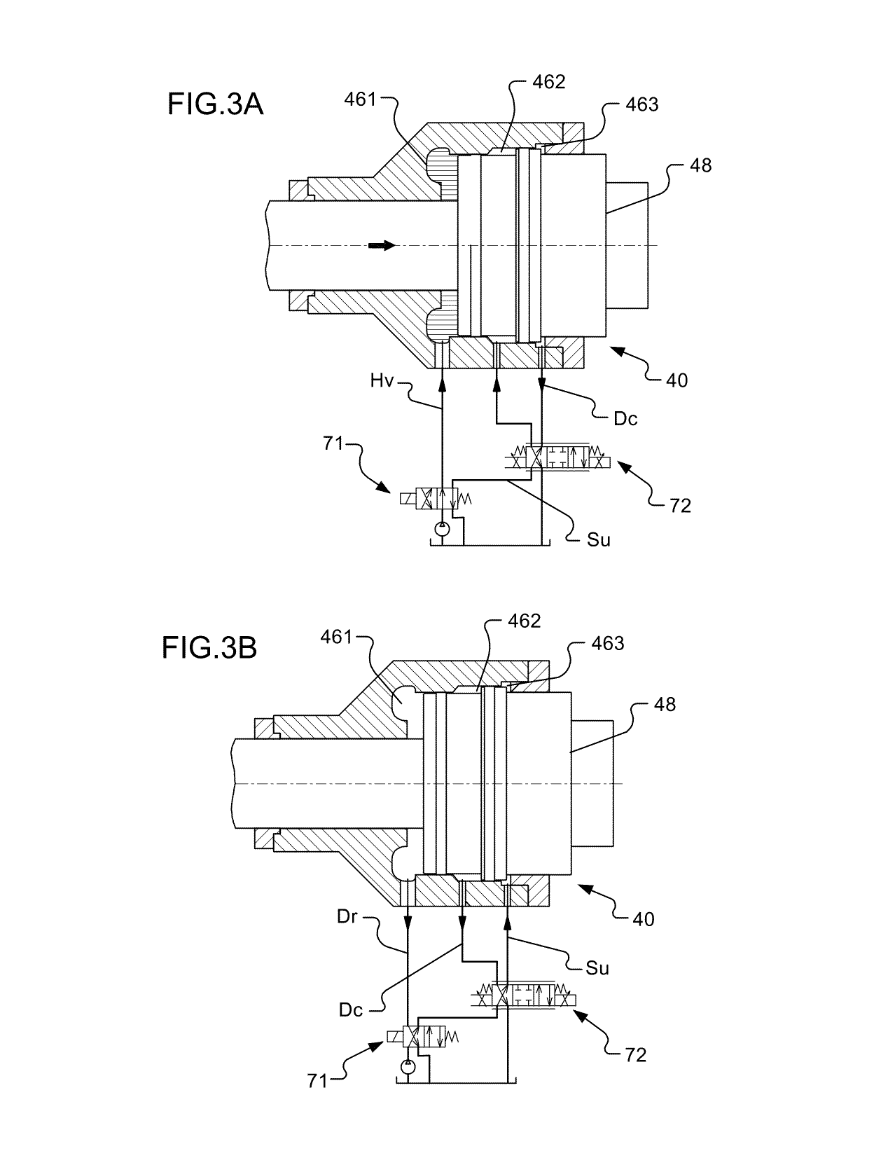

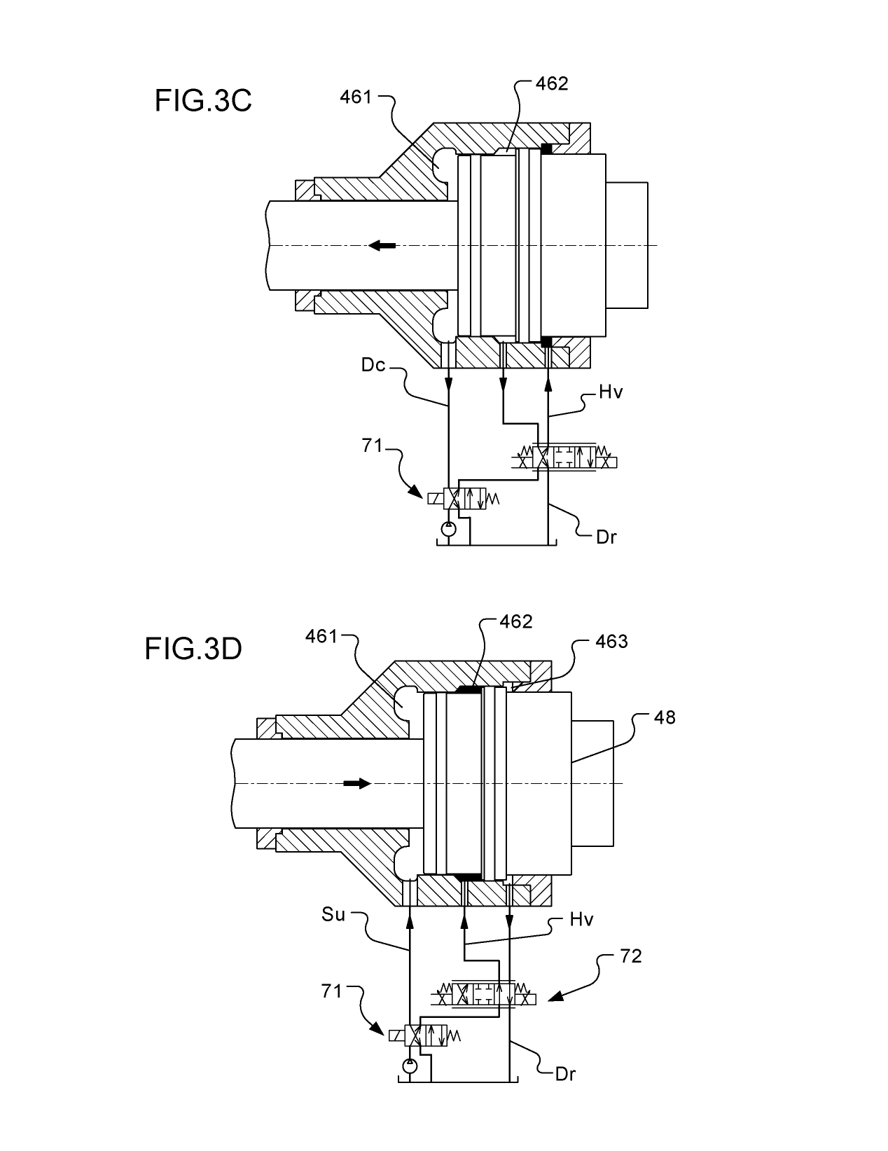

Next, the operation of the mold clamping cylinder 40 performed by controlling each valve of the valve group 70 and the hydraulic device 80 by a signal from the control device 60 to supply/discharge the hydraulic oil to/from each cylinder chamber will be described in detail with reference to FIG. 3. FIG. 3 is a diagram for describing the operation of the mold clamping cylinder 40 according to the present embodiment. In FIG. 3, as in FIG. 2, only the cylinder tube 44 is illustrated in a longitudinal cross section for description.

In FIG. 3, reference numerals 71 and 72 denote valves represented as the valve group 70 in FIG. 1, reference numeral 71 denotes a direction switching valve, and reference numeral 72 denotes a direction switching/flow rate control valve. The direction switching valve and the direction switching/flow rate control valve will be hereinafter referred to as control valves. As the control valve 72, a valve capable of performing closed-loop control of the amount of the hydraulic oil fed to the second cylinder chamber 462 and the third cylinder chamber 463 with high accuracy using the position of the rod 42 or the like detected by a sensor (not illustrated) is used. Part of the control valve 72 may include two valves of a direction switching valve and a flow rate control valve.

The control valve 71 is a valve for switching supply/discharge of hydraulic oil to/from the first cylinder chamber 461, and the control valve 72 is a valve for switching supply/discharge of hydraulic oil to/from the second cylinder chamber 462 and the third cylinder chamber 463. Therefore, in the present embodiment, the mold clamping cylinder 40 can switch the supply/discharge of the hydraulic oil by the two control valves 71 and 72. Note that control valves may be individually provided for the second cylinder chamber 462 and the third cylinder chamber 463. In the present embodiment, the hydraulic oil is supplied to each cylinder chamber by one hydraulic device 80, but a plurality of hydraulic devices may be prepared. Note that the control valve 71 may operate the valve by a solenoid by an electric signal, or may operate the valve by a pilot pressure of hydraulic oil.

As described above, the mold clamping device 1 according to the present embodiment includes four mold clamping cylinders 40, but the first cylinder chamber 461 of the four mold clamping cylinders 40 shares one control valve 71. That is, the supply/discharge of the hydraulic oil to/from the first cylinder chamber 461 of each mold clamping cylinder 40 can be collectively controlled by one control valve 71. On the other hand, the control valve 72 is individually provided for each mold clamping cylinder 40.

Note that the present invention is not limited thereto, and two mold clamping cylinders 40 positioned diagonally may form a pair, and one control valve 71 may be associated with each pair of two mold clamping cylinders 40 in total. That is, the pipelines of the first cylinder chamber 461 of the two mold clamping cylinders 40 are merged and the control valve 71 is interposed therebetween, and the supply/discharge of the hydraulic oil to and from the two first cylinder chambers 461 can be collectively controlled by the control valve 71, and two pairs of such two mold clamping cylinders 40 may be provided. In addition, the control valve 71 may be individually interposed in each of the pipelines of the first cylinder chamber 461 in the four mold clamping devices 1, and the supply/discharge of the hydraulic oil to/from each of the first cylinder chambers 461 may be individually controllable by these four control valves 71. By individually controlling the four mold clamping cylinders 40, it is possible to accurately control the distances of the four points between the fixed mold 11 and the movable mold 21.

As shown in FIG. 3(a), in the mold clamping step, when the half nut 50 is engaged (coupled) with the fitting groove 422 of the rod 42 which is a tie bar, the control valve 71 is switched to a state of supplying the hydraulic oil to the first cylinder chamber 461, and the hydraulic oil is supplied to the first cylinder chamber 461 by the hydraulic device 80, so that the rod 42 is moved in the mold closing direction together with the piston 48, and then the mold clamping cylinder 40 is in the pressure increasing state. The pressure increasing state is a state mainly shifted when mold clamping of the fixed mold 11 and the movable mold 21 is performed. At this time, the volume of the second cylinder chamber 462 increases, while the volume of the third cylinder chamber 463 decreases. That is, since the suction of the hydraulic oil generated by the movement of the piston 48 into the cylinder chamber and the discharge of the hydraulic oil from the third cylinder chamber 463 are performed, the control valve 72 is switched in advance to allow these operations. This switching timing may be substantially the same timing as the supply of the hydraulic oil to the first cylinder chamber 461. Note that reference sign Hv indicates supply of the hydraulic oil at high pressure into the cylinder chamber, reference sign Su indicates suction of the hydraulic oil into the cylinder chamber, and Dc indicates discharge of the hydraulic oil from the cylinder chamber. When the pressure of the hydraulic oil in the first cylinder chamber 461 or the pipeline connected to the first cylinder chamber 461 reaches a predetermined value, the pressure is maintained. In the pressure maintaining state, hydraulic oil is supplied from the pump when the pressure drops to prevent a decrease in the pressure in the first cylinder chamber 461.

As shown in FIG. 3(b), in the pressure releasing step, when the supply of the hydraulic oil is stopped and the control valve 71 is switched so that the hydraulic oil in the first cylinder chamber 461 is discharged to the drain, the mold clamping cylinder 40 is brought into a pressure released state in which the pressure of the hydraulic oil having become high pressure in the first cylinder chamber 461 decreases. The pressure released state is mainly a state of shifting from the pressure maintaining state to the next state after mold clamping of the fixed mold 11 and the movable mold 21. At this time, the control valve 72 is switched in advance so as to allow discharge of the hydraulic oil from the second cylinder chamber 462 and suction of the hydraulic oil into the third cylinder chamber 463. However, when the pressure increasing state transitions to the pressure released state, the control valve 72 is not switched. Reference numeral Dr indicates discharge of the hydraulic oil to the drain.

As shown in FIG. 3(c), in the strong mold opening step, the mold clamping cylinder 40 is in the mold opening state in which the rod 42 moves in the mold opening direction together with the piston 48 when the control valves 71 and 72 are maintained in the same state as the pressure released state and the hydraulic oil is supplied to the third cylinder chamber 463 at a high pressure by the hydraulic device 80 so that the hydraulic oil is supplied into the third cylinder chamber 463 and discharged to the drain in the second cylinder chamber 462. At this time, the volumes of the first and second cylinder chambers 461,462 decrease, while the volume of the third cylinder chamber 463 increases. That is, since the hydraulic oil is discharged from the first and second cylinder chambers 461, the discharge being caused by the retraction of the piston 48 in the mold opening direction, the control valve 71 and the control valve 72 are switched in advance so as to allow these operations. This switching timing may be substantially the same timing as the supply of the hydraulic oil to the third cylinder chamber 463. In the case of shifting from the pressure released state to the mold open state, the control valves 71 and 72 are not switched. In the strong mold opening step, as the rod 42 moves in the mold opening direction, the mold opening force is transmitted to the movable platen 20 and the movable mold 21 via the half nut 50, and the fixed mold 11 and the movable mold 21 are slightly opened (the molded product held by one mold and the cavity surface of the other mold are released).

As illustrated in FIG. 3(d), in the tie bar position adjustment step, the mold clamping cylinder 40 is switched to a state in which the control valves 71 and 72 supply the hydraulic oil to the second cylinder chamber 462, and the hydraulic oil is supplied to the second cylinder chamber 462 by the hydraulic device 80, so that the tie bar position adjustment state in which the rod 42 moves (advances) in the mold closing direction together with the piston 48 is obtained. This state is performed not only at the time of a molding cycle of continuous molding but also at the time of tie bar position adjustment such as after replacement of various molds. At this time, the volume of the first cylinder chamber 461 increases, while the volume of the third cylinder chamber 463 decreases. That is, since the hydraulic oil generated by the movement of the piston 48 is sucked into the first cylinder chamber 461 and the hydraulic oil is discharged from the third cylinder chamber 463, the control valves 71 and 72 are switched so as to allow these operations. This switching timing may be substantially the same timing as the supply of the hydraulic oil to the second cylinder chamber 462. The position adjustment of the piston 48 (position adjustment of the rod 42) in the tie bar position adjustment step is performed at a timing other than the timing from the start of an engagement of the half nut 50 with the rod 42 to the end of the strong mold opening performed by supplying the hydraulic oil to the third cylinder chamber 463. More desirably, the position of the piston 48 is adjusted at a timing when the half nut 50 is not engaged with the rod 42.

Next, the half nut coupling and decoupling between the half nut 50 and the rod 42 and the operation of the mold clamping cylinder 40 related thereto will be described in detail with reference to FIG. 4. FIG. 4 is a diagram for describing the operation. In FIG. 4, for the sake of explanation, one of the two mold clamping cylinders 40 and one of the two half nuts 50 on the lower side of the mold clamping device 1 are illustrated, but it goes without saying that the same operation is performed in the other mold clamping cylinder 40 and half nut 50 and the two mold clamping cylinders 40 and two half nuts 50 on the upper side of the mold clamping device 1.

As described above, the groove width of the fitting groove 422 of the rod 42 is formed to be larger than the tooth width of the fitting tooth 522 of the half nut 50. Preferably, as shown in FIG. 4(a), when the half nut 50 and the rod 42 are in proper positions with respect to each other, a gap t1 is defined on each of both sides of the fitting tooth 522 with respect to the fitting groove 422.

From such a state, as illustrated in FIG. 4(b), the pair of half nut blocks 52 of the half nut 50 is moved forward in a direction of approaching each other, and the fitting tooth 522 enters (fits) the fitting groove 422 to perform half nut coupling. Immediately after this half nut coupling, since the rod 42 is at the position indicated by the two-dot chain line (the same position as the position of FIG. 4(a)), the fitting tooth 522 and the fitting groove 422 are not in contact with each other. After the half nut coupling, the mold clamping cylinder 40 is shifted to the pressure increasing state, so that the rod 42 moves in the mold closing direction via the piston 48 by the gap t1 on one side of the fitting tooth 522, and the mold clamping is performed. Then, in the mold clamping step, pressure is held.

After maintaining the pressure in the mold clamping step, the mold clamping cylinder 40 is shifted to the mold open state as shown in FIG. 4(c) through the pressure releasing step, and strong mold opening step is performed. In the strong mold opening step, the rod 42 moves in the mold opening direction via the piston 48. This movement is performed by the amount of the gap t2 on the other side of the fitting tooth 522, that is, until the one side end face of the fitting tooth 522 contacts the one side inner wall face of the fitting groove 422. As a result, a gap corresponding to the length t2 can be generated between the fixed mold 11 and the movable mold 21.

After the strong mold opening step, as illustrated in FIG. 4(d), the pair of half nut blocks 52 of the half nut 50 is retracted in the direction of being away from each other, the fitting tooth 522 is away from the fitting groove 422, the half nut coupling is released, the movable platen 20 is moved in the mold opening direction until reaching a predetermined mold opening completion position by the mold opening/closing mechanism 30, and the molded product is taken out from the fixed mold 11 or the movable mold 21 by an ejector device (not illustrated) or the like. The timing at which the fitting tooth 522 and the fitting groove 422 are set to the precisely facing positions as illustrated in FIG. 4(a), in other words, the timing at which the mold clamping cylinder 40 shifts to the tie bar position adjustment state and the tie bar position adjustment is performed is only required to be in a period from when the half nut 50 is detached from the fitting groove 422 of the rod 42 after the movable platen 20 and the movable mold 21 reach the predetermined strong mold opening completion position to when the half nut 50 reaches the coupling position, that is, the precisely facing positions of the fitting tooth 522 and the fitting groove 422. In other words, the tie bar position adjustment is performed in a state where the mold clamping force is not transmitted to the movable platen 20 from the start of the release of the half nut coupling to the start of the half nut coupling. The start of the half nut coupling here does not include immediately after the half nut coupling is started. This is because there is a possibility that the fitting tooth 522 of the half nut 50 and the fitting groove 422 of the rod 42 come into contact with each other when the tie bar position adjustment is not finished although the half nut coupling is started. Considering that there is a possibility that a delay in the operation of the tie bar position adjustment may occur, it is preferable that the tie bar position adjustment is performed early during the mold opening of the movable platen 20.

Note that the tie bar position adjustment may be performed, for example, after the strong mold opening, and while starting to move the rod 42 in the mold closing direction as the tie bar position adjustment in the state of the half nut coupling, the half nut coupling may be released in parallel. That is, the tie bar position adjustment can be executed regardless of the mold movement of the movable platen 20.

In the tie bar position adjustment shown in FIG. 4(d), the control valve 72 the flow rate of which is controlled by the closed-loop control is controlled to supply the hydraulic oil to the second cylinder chamber 462, so that the rod 42 moves in the mold closing direction via the piston 48, and it can be seen that the fitting tooth 522 and the fitting groove 422 are in the precisely facing position as shown in FIG. 4(a), that is, the gap t1 is defined on both sides of the fitting tooth 522 with respect to the fitting groove 422. Thereafter, in order to perform the next injection molding, the state illustrated in FIG. 4(a) is shifted to the state illustrated in FIG. 4(b).

Note that the half nut 50 may be decoupled as it is immediately after the strong mold opening, but may be released, for example, after the movable platen 20 is slightly mold opened (further mold opened after the strong mold opening) by the mold opening/closing mechanism 30. The tie bar position adjustment is performed between the start of the release of the half nut coupling and the start of the half nut coupling (timing). However, it is not impossible to perform tie bar position adjustment by supplying the hydraulic oil to the second cylinder chamber 463 before or at the same time as the release of the half nut coupling is started.

According to the present embodiment described above, for example, the mold clamping cylinder 40 can perform its function without separately providing the tie bar movement device including the position adjustment rod, the adjustment cylinder, and the coupling member for performing tie bar position adjustment on the outer wall face of the mold clamping cylinder 40 as in the conventional configuration. Therefore, the number of assembling steps and the number of parts can be reduced, and cost reduction can be realized. In addition, since such a mold clamping cylinder 40 is incorporated in the fixed platen 10, the appearance of the mold clamping device 1 is simple, and the work around the nozzle 92 of the injection device 90 is not hindered. Furthermore, since the second cylinder chamber 462 and the third cylinder chamber 463 for performing tie bar position adjustment are disposed on the outer periphery of the piston 48 of the mold clamping cylinder 40, the length of the mold clamping cylinder 40 in the left-right direction does not increase, and the overall length of the mold clamping device 1 can be reduced as the tie bar movement device is not attached. In addition, there is no need to specially process the wall portion of the first cylinder chamber 461 close to the mold attachment face.

In addition, foam molding may be performed in the mold clamping device 1 according to the present embodiment. In the foam molding, since the resin expands due to foaming after injecting the molten foamed resin into the cavity, it is necessary to open the movable platen 20 and the movable mold 21 by a predetermined stroke, that is, perform mold opening so as to allow the expansion. At this time, the drive source 36 of the mold opening/closing mechanism 30 may be used, but it is preferable to supply the hydraulic oil to the third cylinder chamber 463 while controlling the flow rate. From this, it is preferable that the stroke of each of the first to third cylinder chambers 461 to 463 of the mold clamping cylinder 40 includes a stroke (for example, 20 mm) for adjusting which of the plurality of fitting grooves 422 of the rod 42 matches with the fitting tooth 522 of the half nut 50 (set to the precisely facing position) when the thickness of the mold is changed at the time of mold replacement, and a stroke (for example, 40 mm) for strong mold opening.

The stroke at the time of performing the core back control is included in a stroke for the stroke of the strong mold opening. However, in another special molding, the stroke may be further increased. In the case of foam molding, it is preferable to individually control each of the four-axis rods 42 using individual control valves 71 and 72, but, when any of the four-axis rods 42 is excessively opened, the rod 42 can be pulled back using the second cylinder chamber 462 for closing.

In the mold clamping cylinder 40 according to the present embodiment, the hydraulic oil is supplied to the first cylinder chamber 461 to perform mold clamping after the mold is closed, but the hydraulic oil may be supplied to the second cylinder chamber 462 to perform mold clamping.

In the present embodiment, it is described that at the time of mold clamping, the hydraulic oil is supplied to the first cylinder chamber 461, the hydraulic oil is sucked into the second cylinder chamber 462 according to the movement of the piston 48, and the hydraulic oil in the third cylinder chamber 463 is discharged to the drain, but the present invention is not limited thereto. For example, the second cylinder chamber 462 and the third cylinder chamber 463 may be directly connected by a pipeline, a control valve may be separately provided in the pipeline, and the hydraulic oil in the third cylinder chamber 463 may be circulated to the second cylinder chamber 462. Alternatively, when the hydraulic oil in the first cylinder chamber 361 is depressurized, the hydraulic oil may be simultaneously supplied to the third cylinder chamber 363.

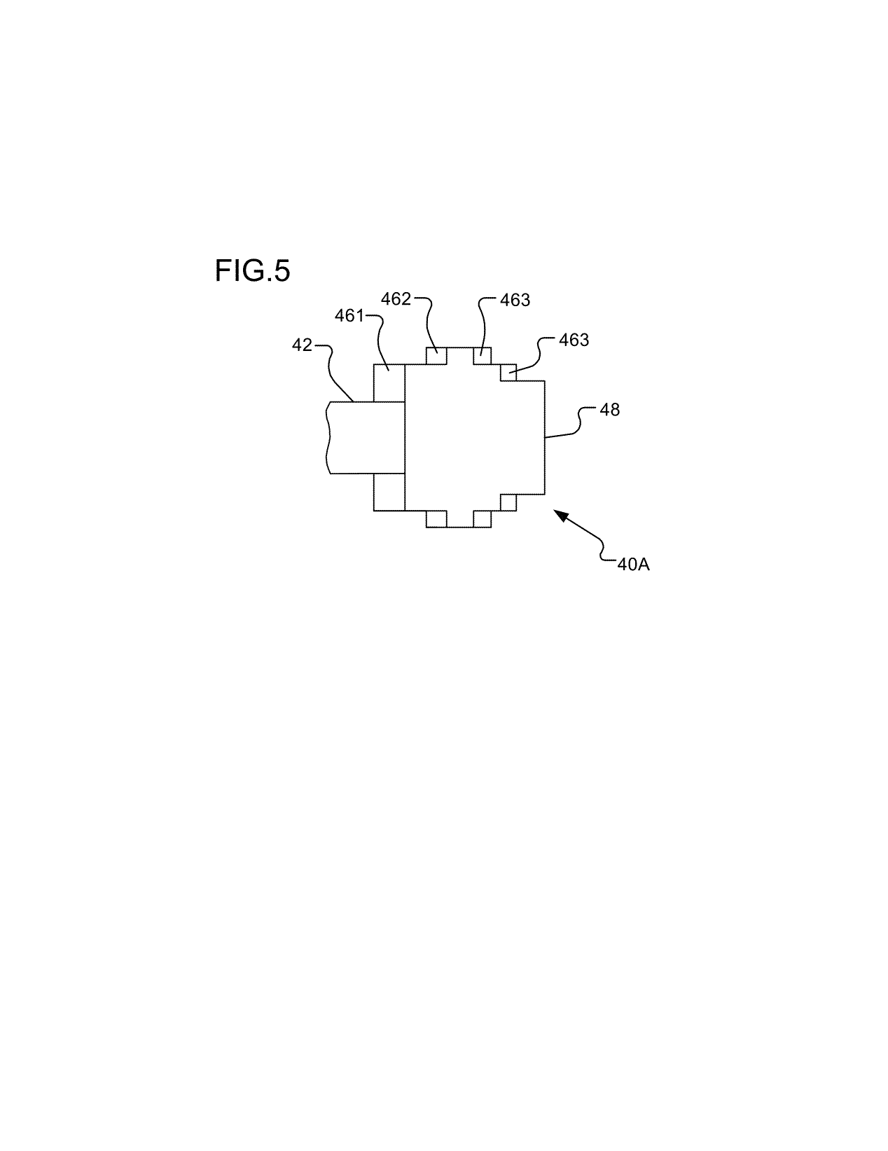

In the present embodiment, since the third cylinder chamber 463 enables the rod 42 to move in the mold opening direction, the tie bar position adjustment (backward movement) and the strong mold opening are performed in common, but the present invention is not limited thereto. As illustrated in FIG. 5, two third cylinder chambers 463 may be provided for the tie bar position adjustment (backward movement) and for the strong mold opening. In this case, it is preferable that both of the two third cylinder chambers 463 are disposed on the outer periphery of the piston 48 of the mold clamping cylinder 40A. The mold opening such as strong mold opening may be performed using a mold opening/closing servomotor without using the third cylinder chamber 463, or may be performed by incorporating a spring in the mold clamping cylinder 40.

In the present embodiment, it is described that the pressure receiving areas of the second cylinder chamber 462 and the third cylinder chamber 463 are substantially the same, but the present invention is not limited thereto. The diameter of the third inner peripheral portion 443 may be decreased and/or the diameter of the second small diameter portion 482 may be increased or decreased so that the pressure receiving area of any one of the pressure receiving areas of the second cylinder chamber 462 and the third cylinder chamber 463 is relatively large.

In the present embodiment, it is described that the mold clamping cylinder 40 is incorporated in the fixed platen 10, but the present invention is not limited thereto, and the mold clamping cylinder 40 may be incorporated in the movable platen 20. In this case, the half nut 50 may be provided on the fixed platen 10 instead of the movable platen 20. In addition, the mold clamping cylinder 40 may be incorporated in the fixed platen 10 and the half nut 50 may be attached, or the mold clamping cylinder 40 may be incorporated in the movable platen 20 and the half nut 50 may be attached. Even in these three developments, the first to third cylinder chambers 461 to 463 can be disposed on the outer periphery of the piston 48 of the mold clamping cylinder 40, and the above-described effects can be achieved.

In addition, the present embodiment and the above-described three developments may be a form including a facing device including an intermediate platen that is rotatable around the rotation shaft between the fixed platen and the movable platen. That is, the present invention can be used for a mold clamping device for performing two-color molding or the like using a plurality of injection devices 90, in a form in which the mold clamping cylinder 40 is incorporated in the fixed platen 10 and the half nut 50 is attached to the movable platen 20, a form in which the mold clamping cylinder 40 is incorporated in the fixed platen 10 and the half nut 50 is attached to the fixed platen 10, a form in which the mold clamping cylinder 40 is incorporated in the movable platen 20 and the half nut 50 is attached to the movable platen 20, and a form in which the mold clamping cylinder 40 is incorporated in the movable platen 20 and the half nut 50 is attached to the fixed platen 10. Similarly, the present embodiment and the three developments described above may be an upright mold clamping device.

In addition, in a so-called 2.5 platen machine such as a mold clamping device including two movable platens being away from each other in a mold opening/closing direction, specifically, one movable platen, and the other movable platen located on the mold opening direction side of the movable platen and functioning as a moving platen for moving the movable platen, one or a plurality of mold clamping cylinders for adjusting a distance between the two movable platens is incorporated into any of the two movable platens. In such a 2.5 platen machine, a columnar ram for biasing the back face of any movable platen extends from one movable platen to the other movable platen, in other words, the ram functions as a transmission member for transmitting a mold clamping force to the movable platen at the time of mold clamping. In other words, the transmission member provided with the piston is a ram provided between the moving platen and the movable platen, and the moving platen is located on the mold opening direction side of the movable platen. A rod which is a tie bar fixedly attached near each of the four corners of the fixed platen has a fitting groove. Further, a half nut having fitted teeth is provided around a hole portion, of the back face of the movable platen, through which the tie bar is inserted. The mold clamping cylinder of the 2.5 platen machine can adjust the distance between the two movable platens by moving the ram. Such a mold clamping cylinder can be the mold clamping cylinder 40 according to the present embodiment, that is, by providing the mold clamping cylinder 40 at one movable platen or the other movable platen, it is possible to impart the effect same as that of the present embodiment to the 2.5 platen machine.

In this case, the mold clamping cylinder 40 moves the ram instead of the rod 42. Further, in the 2.5 platen machine, a form in which the half nut 50 is attached to any movable platen and a form in which the half nut 50 is attached to the fixed platen are considered, but it goes without saying that the mold clamping cylinder 40 can be incorporated in any form. Furthermore, also in the mold clamping device, of the mechanical ram type, having the half nut 50 at the front end of the mold clamping cylinder, the mold clamping cylinder can be the mold clamping cylinder 40 according to the present embodiment, and the effect same as that of the present embodiment can be imparted.

Although embodiments of the invention have been described, the embodiments have been presented as examples, and are not intended to limit the scope of the invention. These novel embodiments can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

What is claimed is:

1. A mold clamping device that mold clamps a movable mold attached to a movable platen movable by a mold opening/closing mechanism and a fixed mold attached to a fixed platen, the mold clamping device comprising:
a mold clamping cylinder including a piston provided at a transmission member that transmits a mold clamping force to the movable platen at a time of the mold clamping, the mold clamping cylinder performing the mold clamping via the transmission member by movement of the piston, wherein
the mold clamping cylinder includes a mold clamping cylinder chamber for moving the piston in a mold closing direction, a mold opening cylinder chamber for moving the piston in a mold opening direction, and an adjustment cylinder chamber located between the mold clamping cylinder chamber and the mold opening cylinder chamber and for adjusting a position of the piston at a timing other than a timing from a start of an engagement of a half nut to an end of strong mold opening.

2. A mold clamping device that mold clamps a movable mold attached to a movable platen movable by a mold opening/closing mechanism and a fixed mold attached to a fixed platen, the mold clamping device comprising:
a mold clamping cylinder including a piston provided at a transmission member that transmits a mold clamping force to the movable platen at a time of the mold clamping, the mold clamping cylinder performing the mold clamping via the transmission member by movement of the piston, wherein
the piston includes a small diameter portion and a large diameter portion, and wherein
the mold clamping cylinder includes
a mold clamping cylinder chamber facing one side face of the small diameter portion and for moving the piston in a mold closing direction,
a mold opening cylinder chamber facing a peripheral face of the small diameter portion and the other side face of the large diameter portion and for moving the piston in a mold opening direction, and
an adjustment cylinder chamber having a pressure receiving area substantially equal to or smaller than a pressure receiving area of the mold opening cylinder chamber, the adjustment cylinder chamber facing a peripheral face of the small diameter portion and one side face of the large diameter portion and for moving the piston in a mold closing direction.

3. The mold clamping device according to claim 1, wherein
the mold clamping cylinder chamber faces one side face of the piston, and has a larger pressure receiving area of the piston than the adjustment cylinder chamber.

4. The mold clamping device according to claim 1, wherein
the mold clamping cylinder is provided inside the fixed platen.

5. The mold clamping device according to claim 1, wherein
a fluid flows into the mold opening cylinder chamber when strong mold opening is performed and when a moving position of the piston in a mold opening direction is adjusted, and wherein
a fluid flows into the adjustment cylinder chamber when a moving position of the piston in a mold closing direction is adjusted.

6. The mold clamping device according to claim 1, wherein
the mold opening cylinder chamber and the adjustment cylinder chamber have substantially a same pressure receiving area of the piston.

7. The mold clamping device according to claim 6, wherein
the piston includes two small diameter portions having substantially a same diameter and a large diameter portion located between the two small diameter portions, wherein
the adjustment cylinder chamber faces at least one side face of the large diameter portion and a peripheral face of one of the small diameter portions, and wherein
the mold opening cylinder chamber faces at least the other side face of the large diameter portion and a peripheral face of the other of the small diameter portions.

8. The mold clamping device according to claim 1, wherein
a transmission member provided with the piston is a tie bar that is inserted through the movable platen so as to be able to guide the movable platen and is allowed to be coupled to the movable platen by a coupling portion.

9. The mold clamping device according to claim 1, wherein
the transmission member provided with the piston is a ram provided between a moving platen and the movable platen, the moving platen located on a mold opening direction side of the movable platen, and wherein
the mold clamping cylinder is provided in the moving platen or in the movable platen.

10. A method of operating a mold clamping device that mold clamps a movable mold attached to a movable platen movable by a mold opening/closing mechanism and a fixed mold attached to a fixed platen, the mold clamping device including
a mold clamping cylinder including a piston provided at a transmission member that transmits a mold clamping force to the movable platen at a time of the mold clamping, the mold clamping cylinder performing the mold clamping via the transmission member by movement of the piston, the method comprising:
causing a fluid to flow into a mold clamping cylinder chamber of the mold clamping cylinder to perform the mold clamping;
causing a fluid to flow into a mold opening cylinder chamber of the mold clamping cylinder to perform mold opening; and
causing a fluid to flow into an adjustment cylinder chamber positioned between the mold clamping cylinder chamber and the mold opening cylinder chamber at least at a time of the mold opening to adjust a position of the piston.
